(19) United States
(12) Patent Application Publication
(10) Pub. No.: US 2007/0211336 A1
(43) Pub. Date: Sep. 13, 2007

(54) POLARIZING PLATE AND LIQUID CRYSTAL DISPLAY

(75) Inventor: Isamu MICHIHATA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA OPTO, INC., Tokyo (JP)

(21) Appl. No.: 11/681,653

(22) Filed: Mar. 2, 2007

(30) Foreign Application Priority Data
Mar. 8, 2006 (JP) JP2006-062419

(51) Int. Cl. G02B 27/28

(52) U.S. Cl. 359/485

(57) ABSTRACT

A polarizing plate comprising a polarizing film and two polarizing plate protective films each having a thickness of 30-60 μm provided on both surfaces of the polarizing film, the polarizing plate further comprising a surface protective film on one surface of the polarizing plate and a release liner on the other surface of the polarizing plate, wherein (A) and (B) simultaneously meet the following conditions, provided that (A) represents a thickness of the surface protective film and (B) represents a thickness of the release liner: Condition (i) 50≦(A)≦200 (μm); Condition (ii) 20≦B) (μm); and Condition (iii) 20≦(A)−(B)≦120 (μm).

This application is based on Japanese Patent Application No. 2006-062419 filed on Mar. 8, 2006 in Japanese Patent Office, the entire content of which is hereby incorparated by reference.

### FIELD OF THE INVENTION

The present invention relates to a polarizing plate and a liquid crystal display, and in more detail to a polarizing plate which exhibits high stiffness, resulting in no generation of wrinkling and position shifting, and a liquid crystal display using the same.

### BACKGROUND OF THE INVENTION

In recent years, liquid crystal displays (LCDs) such as liquid crystal monitors of laptop and desktop computers have spread markedly and a large proportion of monitors in offices and at home have shifted to liquid-crystal displays.

In order to realize a decrease in weight and thickness, LCDs employed in laptop computers are undergoing investigation in which the thickness of all components constituting an LCD is reduced. Specifically, the thickness of back lights has most markedly been reduced. Of these, specifically listed are optical waveguides and lamps (such as cold-cathode tubes (CCFL) and LEDs). Further, for liquid crystal cells, the thickness of the glass plate and the plastic plate employed to seal liquid crystals has also been decreased. Still further, in recent years, a method is employed in which the thickness of polarizing plates adhered onto both sides of the liquid crystal cell is decreased (refer, for example, to Patent Document 1).

Recently, the depth of home television sets has been reduced and large-screen liquid crystal television sets have increasingly become popular. Accordingly, production of liquid crystal displays has significantly increased and in the future, continuing increase is expected.

A liquid crystal television set is sought which exhibits a wider viewing angle, and an elliptical polarizing plate, employing a viewing angle enhancing film, has been employed to realize that. Heretofore, it has been difficult to reduce the thickness of the above elliptical polarizing plate. One of the reasons is that a decrease in the thickness results in degradation of the stiffness of the polarizing plate, and when the elliptical polarizing plate is adhered onto a liquid crystal panel, wrinkling and position shifting tend to occur. Wrinkling causes external appearance problems and position shifting, even though it may be minimal, causes a decrease in contrast. The elastic modulus of the viewing angle enhancing film is lower than that of common TAC film, and when the thickness is reduced, the resulting stiffness is markedly lowered, whereby the above problems tend to occur.

Patent Documents 2 and 3 disclose technologies of polyester film which exhibits excellent optical characteristics of minimal optical anisotropy and interference fringes and also exhibits excellent workability to detect defects of polarizing plates, as a surface protective film which protects an elliptical polarizing plate or as a release liner. In the above documents, an example is described in which a 40 μm surface protective film and a release liner are adhered onto an 80 μm polarizing plate protective film. However, based on investigations by the inventors of the present invention, it was found that under the disclosed constitution, the object of the present invention, that is a decrease in thickness of polarizing plates, was not sufficiently realized and problems of the above mentioned wrinkling and position shifting have not fully been overcome.

(Patent Document 1) Japanese Patent Publication Open to Public Inspection (hereinafter referred to as JP-A) No. 2003-149634

(Patent Document 2) JP-A No. 2000-81515

(Patent document 3) JP-A No. 2000-171636

### SUMMARY OF THE INVENTION

An object of the present invention is to provide a polarizing plate which exhibits sufficient stiffness, causes no wrinkling nor position shifting, and provides a high production yield during the panel lamination process, as well as a liquid crystal display employing the same.

One of the aspects of the present invention to achieve the above object is a polarizing plate comprising a polarizing film and two polarizing plate protective films each having a thickness of 30-60 μm provided on both surfaces of the polarizing film, the polarizing plate further comprising a surface protective film on one surface of the polarizing plate and a release liner on the other surface of the polarizing plate, wherein (A) and (B) simultaneously meet the following conditions, provided that (A) represents a thickness of the surface protective film and (B) represents a thickness of the release liner: Condition (i) 50≦(A)≦200 (μm); Condition (ii) 20≦(B) (μm); and Condition (iii) 20≦(A)−(B)≦120 (μm).

### BRIEF DESCRIPTION OF THE DRAWINGS

FIG. 1 is a schematic view of a polarizing plate to which a surface protective film and a release liner are adhered.

FIG. 2 is a schematic view showing a dope preparation process, a casting process and a drying process in the solution casting method.

FIG. 3 is a schematic view showing one example of the tenter stretching apparatus (10a) employed in the present invention.

FIG. 4 is a view explaining the stretching angle in the stretching process.

FIG. 5 is a schematic view showing one example of the tenter process employed in the present invention.

FIG. 6 is a schematic view of an automatic lamination apparatus.

### DESCRIPTION OF THE PREFERRED EMBODIMENTS

The above object of the present invention is achieved by the following structures.

(1) A polarizing plate comprising a polarizing film and two polarizing plate protective films each having a thickness of 30-60 μm provided on both surfaces of the polarizing film, the polarizing plate further comprising a surface protective film on one surface of the polarizing plate and a release liner on the other surface of the polarizing plate, wherein

(A) and (B) simultaneously meet the following conditions, provided that (A) represents a thickness of the surface protective film and (B) represents a thickness of the release liner.

50≦(A)≦200 (μm) Condition (i)

20≦(B) (μm) Condition (ii)

20≦(A)−(B)≦120 (μm) Condition (iii)

(2) The polarizing plate of Item (1), wherein the surface protective film comprises polyethylene, polyester or polypropylene.

(3) The polarizing plate of Item (1), wherein the surface protective film comprises polyester.

(4) The polarizing plate of any one of Items (1) to (3), wherein the release liner comprises polyethylene, polyester or polypropylene.

(5) The polarizing plate of any one of Items (1) to (3), wherein the release liner comprises polyester.

(6) The polarizing plate of any one of Items (1) to (5), wherein the polarizing plate protective film comprises cellulose ester, polyacrylate or cycloolefine polymer.

(7) The polarizing plate of any one of Items (1) to (6), wherein a thickness of the release liner (B) is 20-50 μm.

(8) The polarizing plate of any one of Items (1) to (6), wherein a thickness of the release liner (B) is larger than 50 μm.

(9) A liquid crystal display comprising the polarizing plate of any one of Items (1) to (8).

Based on the present invention, it is possible to provide a polarizing plate which exhibits sufficient stiffness, causes no wrinkling nor position shifting, and provides a high production yield during the panel lamination process, as well as a liquid crystal display employing the same.

Preferred embodiments to achieve the present invention will be described below, however the present invention is not limited thereto.

The polarizing plate according to the present invention, as described herein, is constituted in such a manner that a polarizing plate which is prepared by laminating both sides of a polarizing film with a polarizing plate protective film which protects both sides of the same, and a surface protective film is adhered onto one side of the above polarizing plate while a release liner is adhered onto the other side. The surface protective film and the release liner are employed to protect the polarizing plate during shipment and inspection. In such a case, the surface protective film is adhered to protect the surface of the polarizing plate and is adhered onto the side opposite to the side which is employed to allow the polarizing plate to adhere to the liquid crystal plate. Further, the release liner is employed to cover the adhesive layer which is adhered to the liquid crystal plate and employed on the surface which allows the polarizing plate to adhere onto the liquid crystal cell.

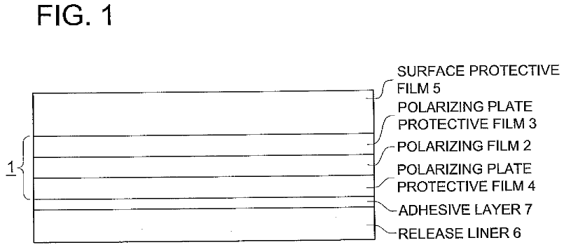

FIG. 1 shows a structural example of the polarizing plate according to the present invention; however the constitution is not limited thereto.

Polarizing plate 1 is constituted in such a manner that polarizing plate protective film 3 and polarizing plate protective film 4 are adhered onto both sides of polarizing film 2 to interpose the same between them. Further, surface protective film 5 is adhered onto one side of the polarizing plate protective film and release liner 6 is adhered via adhesive layer 7 onto the opposite side. Polarizing plate protective films 3 and 4 may be the same or different.

Features of the polarizing plate of the present invention are that a surface protective film is adhered onto one side of a polarizing plate containing a polarizing film and two 30-60 μm thick polarizing plate protective films, and a release liner is adhered onto the opposite side, and the following conditions are satisfied.

50≦(A)≦200 (μm) Condition (i)

20≦(B) (μm) Condition (ii)

20≦(A)−(B)≦120 (μm) Condition (iii)

wherein (A) represents the thickness of the above surface protective film, and (B) represents the thickness of the above release liner.

Since realizing the above constitution makes it possible to enhance stiffness during handling of the polarizing plate, it is possible to reduce the thickness of the polarizing plate itself, whereby it enables to satisfy both of a decrease in the total thickness when the polarizing plate is adhered onto the liquid crystal cell and a high production yield due to no wrinkling and position shifting during the panel lamination process.

The present invention will now be detailed.

### (Surface Protective Film and Release Liner)

Film materials employed to prepare the surface protective film and/or the release liner of the present invention are not specifically limited. Examples may include cellulose ester based film, polyester based film, polycarbonate based film, polyacrylate based film, polysulfone (including polyethersulfone) based film, polyethylene film, polypropylene film, cellophane, polyvinylidene chloride film, polyvinyl alcohol film, ethylene vinyl alcohol film, syndiotactic polystyrene based film, norbornene based resin film, polymethylpentane film, polyether ketone film, polyether ketone imide film, polyamide film, fluororesin film, nylon film, polymethyl methacrylate film, and acryl film. Of these, preferred are the polycarbonate based film and the polyester based film, while the polyester film is most preferred.

Polyesters constituting the polyester based film are not specifically limited, and preferred are those which exhibit capability to form polyester film which is composed mainly of dicarboxylic acid components and diol components.

Cited as dicarboxylic acid components as a major constituting component may be terephthalic acid, isophthalic acid, phthalic acid, 2-6 naphthalenedicarboxylic acid, 2-7 naphthalenedicarboxylic acid, diphenylsulfone dicarboxylic acid, diphenyl ether dicarboxylic acid, diphenylmethane dicarboxylic acid, cyclohexane dicarboxylic acid, diphenylcarboxylic acid, diphenyl thioether dicarboxylic acid, diphenyl ketone dicarboxylic acid, and phenylidene dicarboxylic acid. Further cited as diol components may be ethylene glycol, propylene glycol, tetramethylene glycol, cyclohexane dimethanol, 2,2-bis(4-hydroxyphenyl)propane, 2,2-bis(4-hydroxyethoxyphenyl)propane, bis(4-hydoxyphenyl)sulfone, bisphenolfluorolene dihydroxyethyl ether, diethylene glycol, neopentyl glycol, hydroquinone, and cyclohexanediol.

Of the polyesters composed of the above as a major component, in view of transparency, mechanical strength, and dimensional stability, polyesters are preferred in which the terephthalic acid and/or the 2-6 naphthalene dicarboxylic acid is employed as a dicarboxylic acid component, while the ethylene glycol and/or the diethylene glycol is employed as a diol component. Further, of those, preferred are polyester composed of polyethylene terephthalate or polyethylene 2-6 naphthalate as a major component, copolymerized polyester composed of terephthalic acid, 2-6 naphthalene dicarboxylic acid, and ethylene glycol, and polyester composed of a mixture of at least two types of these polyesters as major components.

When ethylene terephthalate units or ethylene 2-6 naphthalate units are incorporated in an amount of at least 70% by weight with respect to the polyesters, film is obtained which exhibits excellent transparency, mechanical strength, and dimensional stability.

Polyester which constitutes the polyester film which is preferred in the present invention may further be copolymerized with other copolymerization components or may be blended with other polyesters. Listed as such examples may be dicarboxylic acid components and diol components, both listed above, or polyesters composted from them.

Polyester, which constitutes the polyester film, which is preferred in the present invention, may be copolymerized with aromatic dicarboxylic acid having a sulfonate group or ester forming derivatives thereof, dicarboxylic acid having a polyoxyalkylene group or ester forming derivatives thereof, and diol having a polyoxyalkylene group. In view of polyester polymerization reactivity and film transparency, preferred are 5-sodium sulfoisophthalic acid, 2-sodium sultoterephthalic acid, 4-sodium sulfophthalic acid, 4-sodium sulfo-2,6-naphthalene dicarboxylic acid, and compounds which are prepared by replacing sodium of the above compounds with another metal (for example, potassium or lithium), an ammonium salt, or a phosphonium salt, or ester forming derivatives thereof, polyethylene glycol, polytetramethylene glycol, polyethylene glycol-polypropylene glycol copolymers, and compounds which are prepared by oxidizing the hydroxyl groups on both ends to a carboxyl group. Further, to enhance heat resistance of the film, it may be copolymerized with bisphenol based compounds and compounds having a naphthalene ring or a cyclohexane ring.

Antioxidants may be incorporated in the polyesters employed in the present invention. When such a polyester incorporates compounds having a polyoxyalkylene group, antioxidants exhibit significant desirable effects. Types of incorporated antioxidants are not specifically limited and various types of antioxidants may be employed. Listed as such antioxidants may be hindered phenol based compounds, phosphite based compounds, and thioether based compounds. Of these, in terms of transparency, hindered phenol based compounds are preferred as the antioxidant.

The content of antioxidants is commonly Condition (i) 0.01-2% by weight with respect to the polyesters, but is preferably 0.1-0.5%.

If desired, the polyester film employed in the present invention may be provided with lubricating capability. Methods to provide lubricating capability are not specifically limited. Common methods include an external particle incorporation method in which minute inert inorganic particles are added to polyester, an internal particle deposition method in which catalysts, which are incorporated during synthesis of the polyester/are deposited, or a method in which surface active agents are applied onto the film surface.

Synthesizing methods of polyester, which is employed as a raw material of the polyester film of the present invention, are not specifically limited, and may be produced, based on common polyester production methods known in the art. It is possible to employ, for example, a direct esterification method in which dicarboxylic acid components and diol components undergo direct esterification, and a transesterification method in which initially, dialkyl ester is employed as a dicarboxylic acid component, followed by transesterification with a diol component, and polymerization is performed by removing the excessive diol component via heating the resultant reaction product under reduced pressure. In this case, transesterification catalysts or polymerization catalysts are employed if required or it is possible to incorporate heat resistant stabilizers. Further, in each process during the synthesis, incorporated may be anti-coloring agents, antioxidants, crystallization nucleus agents, lubricants, stabilizers, anti-blocking agents, UV absorbers, viscosity controlling agents, antifoaming agents, transparency enhancing agents, antistatic agents, pH controlling agents, dyes, and pigments.

The production method of the polyester employed in the present invention will now be described.

In the present invention, preferred is a polyester film which is biaxially stretched in one direction by a factor of 1.0-2.0 and at right angles to the above direction by a factor of 2.5-7.0. A polyester film is more preferred which is biaxially stretched in the longitudinal direction by a factor of 1.0-2.0 and in the lateral direction by a factor of 2.5-7.0, and is still more preferred which is biaxially stretched in the longitudinal direction by a factor of 1.1-1.8 and in the lateral direction by a factor of 3.0-6.0.

It is possible to produce the above polyester film employing common methods known in the art. Methods are not specifically limited, and it is possible to employ the following method. As used herein, “longitudinal direction” refers to the film casting direction (direction along the length of film) and “lateral direction” refers to the direction in right angles to the film casting direction.

Initially, raw polyester is molded into pellets. After the resulting pellets are subjected to hot air drying or vacuum drying, they are melted, extruded in the form of a sheet from a T-die, brought into close contact with a cooling drum employing an electrostatic charge applying method, cooled and solidified, whereby a non-stretched sheet is produced. Subsequently, the resulting non-stretched sheet is heated to the range of the glass transition temperature (Tg) and Tg+100° C. employing a heating apparatus composed of a plurality of roller groups and/or infrared-ray heaters followed by a single-stage or multi-stage longitudinal stretching.

Subsequently, the polyester film, longitudinally stretched film as above, is laterally stretched within the temperature range of Tg to melting point (Tm)—20° C., followed by thermal fixing.

In the case of lateral stretching, it is preferable to carry out lateral stretching while sequentially elevating temperature in the range of the temperature difference of 1-50° C. in the stretching zone which is divided into at least two sections, since physical property distribution in the lateral direction is leveled. Further, it is preferable that the laterally stretched film is maintained for 0.01-5 minutes in the temperature range of Tm—40° C. to the final lateral stretching temperature, since the physical property distribution in the lateral direction is more leveled.

Thermal fixing is commonly carried out for 0.5-300 seconds in the temperature range of the final lateral stretching temperature to Tm—20° C. It is preferable to carry out the thermal fixing while successively elevating temperature in the range of the temperature difference of 1-100° C. in the zone which is divided into at least two sections.

The heat-fixed film is commonly cooled to at most its Tg, and clip holding portions of both edges of the film are cut off, followed by winding. During the above operation, it is preferable to carry out a relaxation treatment at a ratio of 0.1-10% in the lateral direction and/or the longitudinal direction in the temperature range of at least its Tg to the final thermal fixing temperature. Further, it is preferable to carry out gradual cooling at a temperature lowering rate of at most 100° C. per second from the final thermal fixing temperature to the Tg. Methods to carry out cooling and relaxation treatments are not specifically limited and common methods known in the art are employable. In view of enhancement of the dimensional stability of the film, it is specifically preferable to carry out these treatments under sequential cooling in a plurality of temperature ranges. The temperature lowering rate, as described herein, is the value obtained from formula (T1-Tg)/t, wherein T1 is the final thermal fixing temperature and t is the time during which the film at the final thermal fixing temperature is cooled to Tg.

More appropriate thermal fixing conditions and cooling, relaxation conditions differ depending on the polyester constituting the film. Accordingly, physical properties of the resulting biaxially stretched film are determined, and conditions may appropriately be controlled to achieve targeted characteristics.

Further, when the above film is produced, prior to and/or after stretching, applied may be functional layers such as an antistatic layer, a lubricant layer, an adhesive layer, or a barrier layer. During such application, if required, the film may be subjected to various surface treatments such as a corona discharge treatment or chemical treatments. The clip held portions on both edges cut from the film may be subjected to crushing treatment, and thereafter if needed, to granulation treatment, depolymerization re-polymerization treatment, and may be recycled as a raw material of the same or different type of film.

Polyester film which is cast via stretching only in one direction, as described in the present invention, is produced in such a manner that during the above biaxially stretching, stretching is carried out in either direction. Stretching direction may be either longitudinal or lateral; however, a method is preferred in which stretching and casting is carried out only in the lateral direction. In such a case, the stretching ratio is preferably in the range of a factor of 2.5-7.0, is more preferably in the range of a factor of 3.0-6.0, but is still more preferably in the range of a factor of 4.0-6.0.

The thickness of the polyester film employed in the present invention is characterized by the following conditions:

50≦(A)≦200 (μm) Conditio (i)

20≦(B) (μm) Conditio (ii)

20≦(A)−(B)≦120 (μm) Conditio (iii)

wherein (A) represents the thickness of a surface protective film, and (B) represents the thickness of a release liner.

Thickness (A) of the surface protective film is more preferably 70-150 μm, but is most preferably 80-140 μm. When the thickness of the surface protective film is less than 50 μm, during peeling of the film, wrinkling tends to occur on the polarizing plate and adhesion errors tend to occur. On the other hand, when it exceeds 200 μm, during drawing and handling of polarizing plates, folding and wrinkling tend to occur on the polarizing plate.

Thickness (B) of the release liner is preferably 20-50 μm. When it is less than 20 μm, the supplied water of adhesives becomes excessive, whereby conveyance problems tend to occur due to an increase in curling of the polarizing plate.

The difference between thickness (A) of the surface protective film and thickness (B) of the release liner is in the range of 20-120 μm. When the difference exceeds 120 μm, curling of the polarizing plate tends to result in conveyance problems. On the other hand, when it is less than 20 μm, release liner peeling tends to occur.

Tg of the polyester film of the present invention is preferably at least 50° C., but is more preferably at least 60° C. The Tg is obtained as an average value of a temperature at which the base line, determined by a differential scanning calorimeter, starts deviating and a temperature at which the above base line returns.

In the present invention, in view of productivity, it is preferable that the surface of the surface protective film and/or the release liner is electrically conductive. The surface resistivity (at 23° C. and 25% relative humidity) is preferably at most 1×10¹² Ω/□, is more preferable at most 1×10¹¹ Ω/□, but is still more preferably at most 1×10¹⁰ Ω/□.

In the present invention, methods to result in electrical conductivity are not specifically limited. The electrical conductivity may be provided by incorporation of hygroscopic materials or conductive materials. Examples of materials to result in such conductivity may include surface active agents, conductive polymers, and inorganic metal oxides.

Any of the anionic, cationic, amphoteric and nonionic surface active agents may be employed. Preferred examples include those incorporating an acidic group such as a carboxylic group, a sulfo group, a phospho group, a sulfate ester group, a phosphate ester group, such as alkyl carboxylates, alkyl sulfonates, alkylbenzene sulfonates, alkylnaphthalene sulfonates, alkyl sulfate esters, alkyl phosphate esters, N-acyl-N-alkyltaurinic acid, sulfosuccinate esters, sulfoalkyl polyoxyethylene alkyl phenyl ethers, and polyoxyethylene alkyl phosphate esters.

Examples of preferred cationic surface active agents include alkylamine salts, aliphatic or aromatic quaternary ammonium salts, heterocyclic quaternary ammonium salts such as pyridinium or midazolium, and aliphatic or heterocyclic ring incorporating phosphonium or sulfonium salts.

Examples of preferred amphoteric surface active agents include amino acids, aminoalkylsulphonic acids, aminoalkyl sulfates or phosphate esters, alkylbetaines, and amine oxidet.

Examples of preferred nonionic surface active agents include saponin (steroid based), alkylene oxide derivatives (for example, polyethylene glycol, polyethylene/polypropylene glycol condensation products, polyethylene glycol alkyl ethers or polyethylene glycolalkyl aryl ethers, polyethylene glycol esters, polyethylene glycol sorbitan esters, polyalkylene glycol alkylamines or amides, or polyethylene oxide addition products of silicone), glycidol derivatives (for example, alkenylsuccinic acid polyglycerides and alkylphenol polyglycerides), and alkylesters such as polyhydric alcohol aliphatic acid esters.

Conductive polymers are not specifically limited and may be anionic, cationic, amphoteric, or nonionic. Of these, those preferred are anionic or cationic. Of these, more preferred are sulfone based and carboxylic acid based ones, which are anionic, and tertiary amine based and quaternary ammonium based polymers or latexes which are cationic.

The above conductive polymers may include anionic polymers or latexes described, for example, in Japanese Patent Publication No. 52-25251, JP-A No. 51-29923, and Japanese Patent Publication No. 60-48024, and cationic polymers or latexes described in Japanese Patent Publication Nos. 57-18176, 57-56059, and 58-56856, as well as U.S. Pat. No. 4,118,231.

### (Polarizing Plate Protective Film)

Polarizing plate protective films of the present invention, which protect both surfaces of the polarizing film, are not specifically limited and may include cellulose ester film, polyester film, polycarbonate film, polyarylate film, polysulfone (including polyethersulfone) film, polyethylene terephthalate film, polyester film such as polyethylene naphthalate, polyethylene film, polypropylene film, cellophane, polyvinylidene chloride film, polyvinyl alcohol film, ethylene vinyl alcohol film, syndiotactic polystyrene film, norbonene resin based film, polymethyl pentane film, polyether ketone film, polyether ketoneimide film, polyamide film, fluororesin film, nylon film, cycloolefin polymer film, polymethyl methacrylate film, or acryl film. Of these, preferable are cellulose ester film, cycloolefin polymer film and acryl film. In the present invention, cellulose ester film is preferred as the polarizing plate protective film due to ease of production and high optical transparency. Of cellulose ester films, in view of production, cost, transparency, and adhesion properties, preferred are cellulose triacetate film and cellulose acetate propionate film. Cellulose ester film or cellulose triacetate film produced by a solution casting method is also preferably employed.

### (Cellulose Ester)

It is preferable that cellulose ester used in the present invention is a lower fatty acid ester of cellulose. The lower fatty acid represents a fatty acid having 6 carbon atoms or less. Examples of a specific lower fatty acid ester of cellulose include: cellulose acetate, cellulose propionate, cellulose butyrate and mixed fatty acid esters, for example, cellulose acetate propionate and cellulose acetate butylate, which are disclosed in JP-A Nos. 10-45804 and 08-231761 and U.S. Pat. No. 2,319,052. Specifically, a lower fatty acid ester of cellulose preferably used is cellulose triacetate or cellulose acetate propionate. These cellulose esters may also be used singly or in combination.

When a molecular weight of cellulose ester is too small, tear strength is lowered, but in the case of an excessive amount of the molecular weight, productivity is lowered since viscosity of a cellulose ester solution becomes too high. The molecular weight of cellulose ester is preferably 7000-200000 in number average molecular weight (Mn), and more preferably 100000-200000.

An average acetylation degree (an amount of bonded acetic acid) preferably employed for cellulose triacetate is 54.0-62.5%, and more preferably 58.0-62.5%. In the case of a small average acetylation degree, a dimension variation is large, whereby a polarization degree of the polarizing plate, and in the case of a large average acetylation degree, the dimension variation is large, whereby lowered solubility to a solvent results in lowered productivity.

The preferable cellulose ester other than cellulose is cellulose ester possessing an acyl groups having 2-4 carbon atoms as a substituent, which satisfies following Expressions (I) and (II) at the same time when X is a substitution degree of an acetyl group, and Y is a substitution degree of a propionyl group or a butylyl group.
Expression (I) 2.0≦X+Y≦3.0
Expression (II) 0≦X≦2.5

Among them, cellulose acetate propionate is specifically preferable and that satisfying the relations of 1.0≦X≦2.5 and 0.1≦Y≦1.5 is preferable. The portion which is not substituted by the acyl group is generally occupied by the hydroxy, group. Such the cellulose esters can be synthesized by a commonly known method.

Cellulose ester can be prepared using cotton linter, wood pulp or kenaf as starting materials which may be used alone or in combination. It is specifically preferable to use a cellulose ester prepared from cotton linter (hereafter merely referred to as linter) or from wood pulp singly or in combination.

The polarizing plate protective film of the present invention can contain a plasticizer which gives workability, flexibility, and damp-proof to the film, an ultraviolet absorbent which gives an ultraviolet absorbing function to the film, an antioxidant which prevents deterioration of the film by oxidation, particles which gives a slidability to the film, a retardation controller which controls the film retardation. As a retardation controller, a rod-shaped compound or a compound having 1,3,5-triazine ring is preferably used.

In the cellulose ester film, the following plasticizers are preferably contained. Examples of plasticizers include a phosphoric acid ester based plasticizer, a phthalic acid ester based plasticizer, a trimellitic acid ester based plasticizer, a pyromellitic acid based plasticizer, a glycolate based plasticizer, a citric acid ester based plasticizer, a polyester based plasticizer, and a polyalcohol ester based plasticizer.

Preferably employed as phosphoric acid ester based plasticizers are, for example, triphenyl phosphate, tricresyl phosphate, cresyl diphenyl phosphate, octyl diphenyl phosphate, diphenyl biphenyl phosphate, trioctyl phosphate, tributyl phosphate, and the like. Preferably employed as phthalic acid ester based plasticizers are diethyl phthalate, dimethoxyethyl phthalate, dimethyl phthalate, dioctyl phthalate, dibutyl phthalate, di-2-ethylhexyl phthalate, butylbenzyl phthalate, diphenyl phthalate, dicyclohexyl phthalate, and the like. Preferably employed as trimellitic acid based plasticizers are tributyl trimellitate, triphenyl trimellitate, trimethyl trimellitate, and the like. Preferably employed as pyromellitic acid ester based plasticizers are tetrabutyl pyromellitate, tetraphenyl pyromellitate, tetraethyl pyromellitate, and the like. Preferably employed as glycolate based plasticizers are triacetin, tributyrin, ethylphthalylethyl glycolate, methylphthalylethyl glycolate, butylphthalylbutyl glycolate, and the like. Preferably employed as citric acid ester based plasticizers are triethyl citrate, tri-n-butyl citrate, acetyltriethyl citrate, acetyltri-n-butylcitrate, acetyltri-n-(2-ethylhexyl) citrate, and the like. Examples of other carboxylic acid esters include butyl oleate, methylacetyl recinoleate, dibutyl sebacate, and various trimellitic acid esters.

Employed as polyester based plasticizers may be copolymers of dibasic acids, such as aliphatic dibasic acid, alicyclic dibasic acid, or aromatic dibasic acid with glycol. Aliphatic dibasic acids are not specifically limited. Employed may be adipic acid, sebacic acid, phthalic acid, terephthalic acid, and 1,4-cyclohexyldicarboxylic acid. Employed as glycols may be ethylene glycol, diethylene glycol, 1,3-propylene glycol, 1,2-propylene glycol, 1,4-butylene glycol, 1,3-butylene glycol, and 1,2-butylene glycol. These dibasic acids or glycols may be employed singly or in combination of at least two types.

A polyalcohol ester based plasticizer is composed of at least divalent aliphatic polyalcohol and nonocarboxylic acid ester. The following examples are provided as preferable polyalcohol, but the present invention is not limited thereto. Examples of preferable polyalcohol include adonitol, arabitol, ethylene glycol, diethylene glycol, triethylene glycol, tetraethylene glycol, 1,2-propanediolr 1,3-propanediol, dipropylene glycol, tripropylene glycol, 1,2-butanediol, 1,3-butanediol, 1,4-butanediol, dibutylene glycol, 1,2,4-bunanetriol, 1,5-pentanediol, 1,6-hexanediol, hexanetriol, 2-n-butyl-2-ethyl-1, 3-propanediol, galactitol, mannitol, 3-methylpentane-1,3,5-triol, pinacol, sorbitol, trimethylolpropane, trimethylolethane and xylitol. Specifically, triethylene glycol, tetraethylene glycol, dipropylene glycol, tripropylene glycol, sorbitol, trimethylolpropane and xylitol are preferred. As the monocarboxylic acid to be used in the polyalcohol ester, a known aliphatic monocarboxylic acid, alicyclic monocarboxylic acid and aromatic monocarboxylic acid can be employed though the monocarboxylic acid is not limited. The alicyclic monocarboxylic acid and aromatic monocarboxylic acid are preferable for improving moisture permeability and storage ability. As the preferable aliphatic monocarboxylic acid, a saturated fatty acid such as acetic acid, propionic acid, butylic acid, valeric acid, caproic acid, enantic acid, caprylic acid, pelargonic acid, capric acid, 2-ethyl-hexane carboxylic acid, undecylic acid, laurie acid, dodecylic acid, myristic acid, pentadecylic acid, palmitic acid, heptadecylic acid, stearic acid, nonadecanic acid, arachic acid, behenic acid, lignocelic acid, cerotic acid, heptacosanic acid, montanic acid, melisic acid or lacceric acid, and a unsaturated fatty acid such as undecylenic acid, oleic acid, sorbic acid, linolic acid, linolenic acid and arachidonic acid can be exemplified.

Examples of preferable alicyclic monocarboxylic acid include cyciopentene carboxylic acid, cyclohexane carboxylic acid, cyclooctane carboxylic acid and derivatives thereof. The molecular weight of the polyalcohol is preferably 300-1,500, and more preferably from 350 to 750 though the molecular weight is not specifically limited. Larger molecular weight is preferable for storage ability, and smaller molecular weight is preferable for moisture permeability and compatibility with the cellulose ester.

The carboxylic acid used for polyalcohol ester may be used singly or in combination with al least two types. OH-groups in the polyalcohol may be entirely esterified by a carboxylic acid, or OH groups may be partly left.

These plasticizers may be used singly or in combination.

In view of film performance and workability, the consumption amount of the plasticizer to be used is preferably 1-20% by weight, and more preferably 3-13% by weight.

### (UV Absorbent)

It is preferred that a UV absorbent is added into a substrate, in the present invention.

Preferably employed as UV absorbents which efficiently absorb UV radiation of wavelengths shorter than 370 nm and minimally absorb visible light of wavelengths longer than 400 nm to result in good liquid crystal display properties.

Specific examples of UV absorbers which are preferably employed in the present invention include, oxybenzophenone based compounds, benzotriazole based compounds, salicylic acid ester based compounds, benzophenone based compounds, cyanoacrylate based compounds, triazine based compounds and nickel complex salt based compounds, however, the present invention is not limited thereto.

Preferably employed as benzotriazole based UV absorbents are compounds represented by Formula (A) described below.

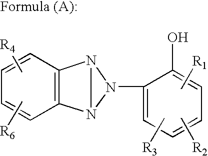

where R₁, R₂, R₃, R₄, and R₅ may be the same or be different, and each represents a hydrogen atom, a halogen atom, a nitro group, a hydroxyl group, an alkyl group, an alkenyl group, an aryl group, an alkoxy group, an acyloxyl group, an aryloxy group, an alkylthio group, an arylthio group, a monoalkylamino group or a dialkylamino group, an acylamino group, or a heterocyclic group of 5-6 members; and R4 and R5 may be combined to form a 5-6 membered ring.

Each of the above mentioned groups may have an arbitrary substituent.

Next, examples of UV absorbents used for the present invention are specifically provided, but the present invention is not limited thereto.

UV-1: 2-(2′-hydroxy-5′-methylphenyl)benzotriazole

UV-2: 2-(2′-hydroxy-3′,5′-di-tert-butylphenyl)benzotriazole

UV-3: 2-(2′-hydroxy-3′-tert-butyl-5′-methyiphenyl)benzotriazole

UV-4: 2-(2′-hydroxy-3′,5′-di-tert-butylphenyl)-5-chloro benzotriazole

UV-5: 2-(2′-hydroxy-3′-(3″,4″,5″,6″-tetrahydro phthalimidomethyl)-5′-methylphenyl)benzotriazole

UV-6: 2,2-methylenebis(4-(1,1,3,3-tetramethyibutyl)-6-(2H-benzotriazole-2-yl)phenol)

UV-7: 2-(2′-hydroxy-3′-tert-butyl-5′-methylphenyl)-5-chlorobenzotriazole

UV-8: 2-(2H-benzotriazole-2-yl)-6-(n- and iso-dodecyl)-4-methylphenol (TINUVIN171, product of Ciba Specialty Chemicals Inc.)

UV-9: Mixture of octyl-3-[3-tert-butyl-4-hydroxy-5-(chloro-2 H-benzotriazole-2-yl)phenyl]propionate and 2-ethylhexyl-3-[3-tert-butyl-4-hydroxy-5-(5-chloro-2H-benzotriazole-2-yl) phenyl]propionate (TINUVIN109, product of Ciba Specialty Chemicals Inc.)

The compound represented by the following Formula (B) is preferably used as a benzotriazole UV absorbent

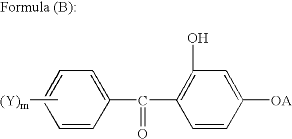

where Y represents a hydrogen atom, a halogen atom, an alkyl group, an alkenyl group, an alkoxyl group, or a phenyl group, and the alkyl group, the alkenyl group, and the phenyl group may have a substituent; A represents a hydrogen atom, an alkyl group, an alkenyl group, a phenyl group, a cycloalkyl group, an alkylcarbonyl group, an alkylsulfonyl group, or a —CO(NH)ₙ₋₁-D group, wherein D represents an alkyl group, an alkenyl group or a phenyl group which may have a substituent; and m and n each represent 1 or 2.

In the above description, the alkyl group represents, for example, a normal or branched aliphatic group having not more than 24 carbon atoms, the alkoxyl group represents, for example, an alkoxyl group having not more than 18 carbon atoms, and the alkenyl group represents, for example, an alkenyl group having not more than 16 carbon atoms, such as an allyl group or a 2-butenyl group. Examples of a substituent to the alkyl group, the alkenyl group, and the phenyl group include, for example, a halogen atom such as a chlorine atom, a bromine atom or a fluorine atom, and a hydroxyl group and a phenyl group (the phenyl group may further have an alkyl group or a halogen atom as a substituent).

Specific examples of a benzophenone based compound represented by Formula (B) are shown below, however, the present invention is not limited thereto.
UV-10: 2, 4-dihydroxy benzophenone
UV-11: 2,2′-dihydroxy-4-methoxybenzophenone
UV-12: 2-hydroxy-4-methoxy-5-sulfobenzophenone
UV-13: Bis(2-methoxy-4-hydroxy-5-benzoylphenyl methane)

UV absorbents which are preferably employed in the present invention include benzotriazole based UV absorbents and benzophenone based UV absorbents which exhibit high transparency and excellent effects to minimize degradation of polarizing plates as well as liquid crystals. Of these, more preferably employed are benzotriazole based UV absorbents which exhibit less undesired coloration.

Further, UV absorbents at a distribution coefficient of at least 9.2, described in JP-A No. 2001-295209, enhance the surface quality of supports and exhibit excellent coating properties. It is specifically preferable to use UV absorbents of a distribution coefficient of at least 10.1.

Further, preferably employed are polymer type UV absorbers (or UV radiation absorptive polymers) represented by Formula (1) or (2) described in JP-A No. 6-148430 and represented by Formulas (3), (6), and (7) described in JP-A No. 2000-156039. As a polymer type UV absorber, PUVA-30M (manufactured by Otsuka Chemical Co., Ltd.) is commercially available.

### (Particles)

In the present invention, particles are preferably contained in a cellulose ester film, in order to provide, for example, lubricity. Example of the particles include inorganic particles such as particles made of silicon dioxide, titanium dioxide, aluminum oxide, zirconium oxide, calcium carbonate, kaolin, talc, baked calcium silicate, hydrated calcium silicate, aluminum silicate, magnesium silicate or phosphate, and crosslinked polymer particles. Among them, silicon dioxide is preferable since the haze of the film can be lowered. A secondary particle average particle diameter of the particles are in the range of 0.01-1.0 μm, and the content is preferably 0.005-0.3% by weight. It is preferable to be possible to lower the haze of such films, though particles such as silicon oxide and the like are usually surface-treated by an organic substance. The 38 8022 preferable organic compound for the surface treatment includes halosilane, alkoxysilane (specifically having a methyl group), silazane and siloxane. The particles having lager average diameter displays higher matting effect and one having lower average diameter is superior in transparency. The primary particle average particle diameter is preferably in the range of 5-50 nm, and more preferably in the range of 7-16 nm. It is preferred that these particles are usually coagulated in a cellulose ester film as coagulated particles, whereby a roughened surface of 0.01-1.0 μm is formed on the cellulose ester film surface. Examples of silicon dioxide particles include AEROSIL 200, 200V, 300, R972, R972V, R974, R202, R812, OX50, TT600 and so forth, each manufactured by Nippon Aerosil Co., Ltdr and Aerosil 200V, R972, R972V, R974, R202 and R812 are preferable. These particles may be employed in combination with two or more kinds thereof. In the case of being used in combination with two or more kinds, they can be mixed at an arbitrary content ratio to be used. In such the case, Particles having a different particle diameter, made of a different material may be employed, for example, AEROGIL 200V and R972V can be used at weight ration in the range of 0.1:99.9-99.9:0.1. In the present invention, particles contained with cellulose ester, other additives, and an organic solvent may be dispersed during adjusting a dope, but it is preferable that a dope is adjusted in the state of another particle dispersion sufficiently dispersed with a cellulose ester solution. In order to disperse particles, it is preferred that a fine dispersing process is conducted by a homogenizer possessing a high shear force(high pressure homogenizer), after immersing in an organic solvent in advance. It is preferable that the resulting solution is dispersed in a larger amount of organic solvent after this, and combined with a cellulose ester solution to make a dope by mixing with an in-line mixer. In this case, a UV absorbent may be added into the particle dispersion to make a UV absorbent liquid.

The above degradation preventing agent, UV absorbent and/or particles may be added with cellulose ester and a solvent when a cellulose ester solution is prepared, or may be added during or after preparing the solution.

The production method of cellulose ester film is not specifically limited, however, usually cellulose ester film is produced by a solution-casting method or a melt-casting method.

### (Organic Solvent)

There is no particular restriction to the organic solvent helpful in preparing the dope of the cellulose ester film used, when the cellulose ester film is formed via a solution-casting method, in the present invention, if it simultaneously dissolve cellulose ester and other additives. For example, methylene chloride can be mentioned as a chlorine-based organic solvent. The non-chlorine-based organic solvent is exemplified by methyl acetate, ethyl acetate, amyl acetate, acetone, tetrahydrofuran, 1,3-dioxolane, 1,4-dioxane, cyclohexanone, formic acidethyl, 2,2,2-trifluoro ethanol, 2,2,3,3-hexafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol, and nitroethane. Methylene chloride, methyl acetate, ethyl acetate and acetone can be preferably used. Use of methyl acetate is specifically preferred.

The dope of the present invention preferably contains 1-40% by weight of alcohol having 1-4 carbon atoms, in addition to the aforementioned organic solvent. An increase in the percentage of alcohol in the dope causes gelation of the web, resulting in easy separation from the metal supporting member. A smaller amount of alcohol promotes dissolution of the cellulose ester in the non-chlorine-based organic solvent. Examples of the alcohol having 1-4 carbon atoms include: ethanol, n-propanol, iso-propanol, n-butanol, sec-butanol and tert-butanol. Of these substances, use of ethanol is preferred because of dope stability, relatively low boiling point and excellent drying property.

### <Film Production>

Hereafter, a desirable film-production method of a polarizing plate protective film of the present invention will be explained.

### 1) Dissolution Process:

In this process, cellulose ester is dissolved in an organic solvent which mainly contains good solvent, in a vessel while stirring a mixture of a cellulose ester, an additive and a solvent so as to form a dope or an additive solution is mixed in a cellulose ester solution so as to form a dope.

As a method of dissolving a cellulose derivative by ordinary pressure, although various methods such as a method of performing under the ambient pressure, a method of performing under a temperature below the boiling point of the main solvent, a method of performing under a temperature above the boiling point of the main solvent while applying a pressure, a method of performing a cooling dissolving method described in the official gazettes of JP-A Nos. 9-95544, 9-95557 and 9-95538, a method of performing under a high pressure described in the official gazette of JP-A No. 11-21379 can be employed, a method of performing under a temperature above the boiling point of the main solvent while applying a pressure especially is desirable.

The concentration of the cellulose ester in a dope is preferably 10-35% by weight. After adding an additive into the dope while dissolving or after dissolving, the dope is filtered with a filer media and defoamed, and then the dope is sent to the following manufacturing process with a feeding pump.

Regarding filtration, it is preferable to employ filters at a catching particle diameter of 0.5-5 μm and a water filtering time of 10-25 seconds/100 ml. In this method, by employing the filter at a catching particle diameter of 0.5-5 μm and a water filtering time of 10-24 seconds/100 ml, it is possible to remove only aggregates, which remain during minute particle dispersion and are generated during the addition of the main dope. In the main dope, since the concentration of minute particles is much lower than that of the addition liquid, no rapid increase in filtration pressure due to mutual adhesion of aggregates during filtration occurs.

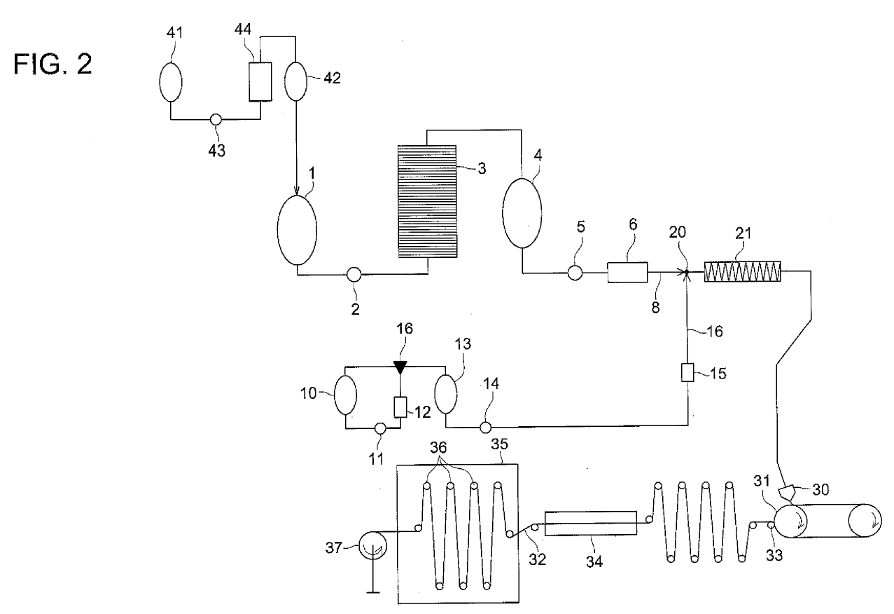

FIG. 2 is a schematic view showing the dope preparation process, the casting process and the drying process of the preferred solution casting method of the present invention. Large coagulants in minute particle preparation kettle 41 are removed though filter 44, and the filtrate is conveyed to storage kettle 42. Subsequently, a minute particle addition liquid is added to main dope dissolution kettle 1 from storage kettle 42. Thereafter, the main dope liquid is filtered through main filter 3, to which a UV absorber addition liquid is added in-line from 16. In FIG. 2, other notes represent the following members: 2, 5, 11, 14, 43 pump; 6, 12, 15 filter; 4, 13 storage tank; 8, 16 pipe; 10 UV absorber charging vessel; 20 junction pipe; 21 mixer; 30 die; 31 metal support; 32 web; 33 peeling position; 34 tenter apparatus; 35 roller drying apparatus; 37 winding roll; and 41 particle charging vessel.

In many cases, recycled polyester is incorporated in the main dope in an amount of about 10 to about 50% by weight. Since minute particles are incorporated in the recycled polyester, it is preferable that the addition amount of the minute particle addition liquid is controlled depending on the addition amount of the recycled polyester. The content of minute particles in an addition liquid incorporating minute particles is preferably 0.5-10% by weight, is more preferably 1-5% by weight, but is most preferably 1-3% by weight. When the content of minute particles is low, the resulting viscosity decreases resulting in easer handling, while when it is high, the addition amount of the addition liquid decreases resulting in easer addition to the main dope. Consequently, the above range is preferred. “Recycled polyester”, as used herein, refers to finely crushed cellulose ester film, which includes both sides of cut film and cellulose film mill rolls beyond specification due to abrasion and the like.

### 2) Casting Process:

In this casting process, a dope solution is sent to a pressure die using a feeding pump (for example, a pressurized metering gear pump) and cast on an endless metal belt, for example, a stainless steel belt, or on a rotating cylindrical metal support at a prescribed position from the pressure die.

A pressure die is preferable since uniform thickness is more easily obtained by adjusting the slit shape at the tip of a die. A pressure die includes a coat-hanger die and a T die either of which are preferably used. Two pressure dies may be provided simultaneously on a metal support to increase the film forming rate by dividing the amount of dope and by superimposing two film layers. Or it is also desirable to obtain a film of a laminated structure by a multi casting method to conduct casting of plural dope solutions simultaneously.

### 3) Solvent Evaporation Process:

A web (a film of a dope after the dope is cast on a metal support is referred to as a web) is heated on a metal support to evaporate the contained solvent until the web becomes peelable.

The following methods may be used to promote evaporation of a solvent from a web: blowing from above the web; heating a metal support from a back surface using a liquid heat medium; and heating from both surfaces of a web using radiant heat. Among these methods, the method to heat a metal support from a back surface using a liquid heat medium is preferable with respect to drying efficiency, however the above methods may also be used in combination. In the case of heating a back surface using a liquid heat medium, it may be preferable to heat at a temperature lower than the boiling point of the main solvent of an organic solvent used in the dope or lower than the boiling point of an organic solvent having a lowest boiling point.

### 4) Peeling Process

A web dried on a metal support is peeled from the metal support at a prescribed position. The peeled web is sent to the next process. If the amount of the residual solvent (below-mentioned formula) in a web is too much at the point of peeling, peeling is difficult and if the amount of the residual solvent is too small, partial peeling of the web may occur prior to the point of peeling.

As an alternate method to increase the formation rate of a web (by peeling while an amount of the residual solvent is as much as possible, the formation rate of a web can be increased), a gel casting method may be used. This method enables a higher forming rate of a web since a web is peeled while the web still contains a high percentage of solvent. In a gel casting method, the gel is formed by: adding a considerable amount of a poor solvent for the cellulose ester in a dope which forms a gel after casting the dope on a metal support; or lowering the temperature of the metal support to facilitate formation of a gel. By forming a gel, the mechanical strength of a web increases and an early peeling of the web becomes possible, resulting in a higher web formation rate.

With regard to the amount of the residual solvent on the metal support, it may be preferable to peel the web in a range of 5 to 150% by mass depending on the degree of a drying condition and a length of the metal support. In the case of peeling it when the amount of the residual solvent is too much, if the web is to soft, the web may lose a flatness at the time of peeling, or apt to cause twist or longitudinal streak by the peeling tension. Accordingly, the amount of the residual solvent when peeling is determined in view of both of an economic speed and a quality. In the present invention, the temperature at the point of peeling from the metal support is preferably controlled between—50° C. and 40° C., is more preferably 10° C. to 40° C., and is still more preferably 15° C. to 30° C.

The amount of residual solvent at the point of peeling on the metal support is preferably 10 to 150% by weight, is more preferably 10 to 120% by weight.

The amount of the residual solvent is defined by the following equation:

Residual solvent content (% by weight)={(M−N)/N}×100

where M represents weight of samples of the web taken during or after the manufacturing process, and N represents weight of the same sample after it has been dried at 115° C. for one hour.

### 5) Drying and Stretching Process:

After peeling, the web is dried using a drying equipment which conveys the web by passing it alternately among a plurality of rolls arranged in the drying equipment, and/or a tenter stretching apparatus which clips the both ends of a web and conveys it with a clip, thereby drying the web.

In the tenter stretching apparatus, it is preferable that the holding lengths (the holding length being the length of the web from the beginning of holding to the end of holding) of the left side edge and the right side edge of the film can be independently controlled.

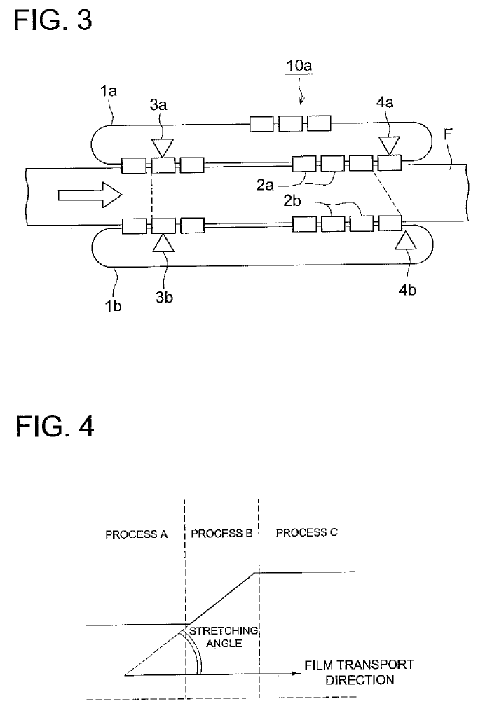

FIG. 3 illustrates a tenter stretching apparatus preferable for the present invention.

In this figure, by changing the positions of holding members (clips) (2a) (2b) of left and right, namely, by changing the set positions of clip closers (3a) (3b) of left and right to change the start positions of holding of left and right edges, the left and right holding lengths of film (F) are changed, whereby a forth to twist resin film (F) is generated. By the forth to twist the film, the displacement occurred in the transport process other than in tenter (10) is corrected, and the occurrence of meandering, tensile or wrinkle of the film can be effectively avoided.

Further, though tenter stretching apparatus (10a) in the figure is schematically shown, a usual arrangement is as follows. Many clips (2a) (2b) are equipped on a pair of rotating devices arranged on left and right sides, each rotating device containing a looped chain (1a) (1b). The track of each of the left and right chains (1a) (1b) is set so that the clips moving in the forward direction of the chains, which hold the left and right edges to stretch the film, gradually draw apart from the film (F) toward the lateral direction of the film, whereby the film (F) is stretched in the lateral direction. In FIG. 3, 4a represent a clip opener of the left side, and 4b represents a clip opener of the right side.

In order to precisely correct the wrinkle, tensile, and displacement, a device which avoids the meandering of the long roll film is preferably equipped. It is preferable that an edge position controller (also referred to as EPC) disclosed in JP-A No. 6-8663, or a center position controller 50 8022 (also referred to as CPC) is used to correct meandering. These devices detect the edges of the film with an air servo sensor or an optical sensor to control the transport of the film using the obtained information, whereby the edge positions and the center position of the film with respect to the lateral direction are kept constant while the film is transported. One or two guide rolls or a flat expander roll having a driving member as actuators are moved to the right and left (or up and down) along the line to correct the meandering. A pair of small pinch rolls are placed on each of the right and left of the film (one of the pair of pinch rolls is placed on the front surface of the film and the other is placed on the back surface of the film, wherein the two pairs of the pinch rolls are located on both sides of the film), whereby the film is sandwiched and pulled to correct meandering (a cross guide method). The principle of meandering correction of these devices can be described as follows: When the running film tends to move to the left, the roll is tilted so as to move the film to the right, in the former method, and in the latter method, a pair of pinch rolls on the right nip the film to pull it to the right. At least one of the aforementioned meandering preventive apparatuses is preferably installed between the peeling point of the film and the tenter stretching apparatus.

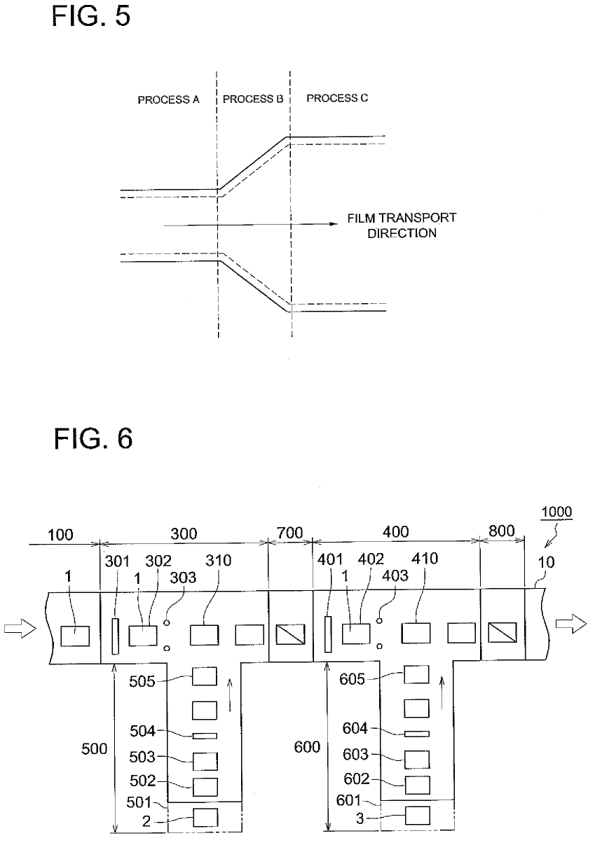

An example of the tenter stretching process (also referred to as the tenter process) of the present invention will now be explained using FIG. 5.

Process A of FIG. 5 is the process where a film conveyed from transporting process D0 (not illustrated) is held by clipping both edges in Process B, the film is stretched in the lateral direction (perpendicular to the film transportat direction) with the stretching angle illustrated in FIG. 4. In Process C, stretching is completed and the film is transported to the next production process while being clipped.

A slitter which trims the edge of the lateral direction of the film is preferably provided (i) between just after the web is peeled and before Process B; and/or (ii) just after Process C. Specifically preferably, a slitter is provided just before Process A. When a stretching was carried out under the same condition, a stretched film which is slit before Process B showed an improved orientation angle distribution compared to a stretched film without slitting. The orientation angle represents an in-plane angle between a slow axis and the lateral direction of the cast cellulose ester film.

This may be because an undesirable stretching in the film transport direction is suppressed between the peeling process and Process B where the film still contains much solvent.

In the tenter process, a different temperature domain may be purposely provided in the film to improve the retardation distribution. Also a neutral domain is preferably provided between two different temperature domains to prevent interference.

The stretching process may be divided into several steps. Biaxial stretching in both film transport direction and the lateral direction is also preferable. Biaxial stretching may be carried out simultaneously or in series of steps. In stepped stretching, stretching may be carried out alternately in different directions or stepwise in one direction. Stretching alternately in different directions may also be added to the sequence of stepped stretching in one direction. Namely, the following stretching steps are also employable.

(i) Stretching in the film transport direction—stretching in the lateral direction—stretching in the film transport direction—stretching in the film transport direction; and

(ii) Stretching in the lateral direction—stretching in the lateral direction—stretching in the film transport direction—stretching in the film transport direction.

The simultaneous biaxial stretching includes stretching in one direction while relaxing the tension in the other direction whereby the film shrinks in that direction. Preferable stretching ratios in the simultaneous biaxial stretching are: 1.05-1.5 times in the lateral direction and 0.8-1.3 times in the film transport direction; more preferably 1.1-1.5 times in the lateral direction and 0.8-0.99 times in the film transport direction; and specifically preferably 1.1-1.4 times in the lateral direction and 0.9-0.99 times in the film transport direction.

The term “stretching direction” used in the present invention usually represents the direction in which stretching tension is applied, however, when a web is biaxially stretched in a plurality of steps, the “stretching direction” may mean the direction in which the final stretching ratio of the web becomes larger (which is usually the slow axis direction). Specifically, when dimensional variation ratio of the film is discussed, the stretching direction mainly refers to the latter meaning.

It is well known that, when a web is stretched in the lateral direction of the film, the dispersion of orientations of slow axes (hereafter referred to as a orientation angle dispersion) becomes larger. In order to conduct stretching in the lateral direction of a web while the ratio of Rt to Ro is kept constant and the orientation angle dispersion is kept small, relationships among web temperatures of processes A, B and C exist, namely, the following relationships are preferably satisfied: Ta≦(Tb−10), or Tc≦Tb, and more preferably the both relationships are simultaneously satisfied: Ta≦(Tb−10) and Tc≦Tb, wherein Ta, Tb and Tc represents temperatures in Celsius at each end of Processes A, B and C, respectively.

In order to decrease the above mentioned orientation angle dispersion, the temperature increasing rate of the web in Process B is preferably 0.5-10° C./s.

In order to reduce the dimensional variation ratio after treated under a condition of 80° C. and 90% RH, the stretching duration in Process B is preferably shorter, however, a lower limitation of the stretching duration may be prescribed to maintain uniformity of the web. The temperature of Process B is preferably 40-180° C., and more preferably 100-160° C.

In the tenter process, the coefficient of heat transfer may be constant or may be changed. The heat transfer coefficient is preferably in the range of 41.9×10³—419×10³ J/m²h, more preferably 41.9×10³—209.5×10³ J/m²h, and further more preferably 41.9×10³—126×10³ J/m²hr.

In order to improve the dimensional stability after treated under a condition of 80° C. and 90% RH, the stretching rate in the lateral direction in Process B may be constant or may be changed. The stretching rate is preferably in the range of 50-500%/minute, more preferably 100-400%/minute, and most preferably 200-300%/minute.

In the tenter process, the distribution of environmental temperature in the lateral direction of the film is preferably smaller to improve uniformity of a film. The distribution of environmental temperature in the lateral direction in the tenter process is preferably within ±5° C., more preferably within ±2° C., and most preferably within ±1° C. By decreasing the distribution of environmental temperature, the temperature distribution in the lateral direction of a web may also be decreased.

In Process C, the width of a film is preferably reduced, in order to reduce the dimensional variation. Specifically, the width is preferably reduced to 95 to 99.5% of the width in the former process.

After treatment in the tenter process, it is preferable to provide a post-drying process (hereinafter referred to as process D1). The length of the drying zone after the tenter process is 500-6,000 m. It is preferable that conveyance is carried out employing 400-15,000 conveyance rollers. In the drying zone after the tenter process, drying temperature is preferably 100-200° C., but is more preferably 110-160° C.

In-plane retardation (Ro) in the polarizing plate protective film according to the present invention is preferably in the range of 15-300 nm, is more preferably in the range of 15-150 nm, but is most preferably in the range of 15-70 nm. On the other hand, retardation (Rt) in the film thickness direction is preferably in the range of 0-1,000 nm, is more preferably 50-500 nm, but is most preferably 70-300 nm.

Further, when a cellulose ester film is stretched in the lateral direction, it is essential to carry out the above stretching while controlling the orientation angle distribution in the lateral direction within a certain range. It is possible to determine the orientation angle, employing an automatic birefringence meter KOBURA-21ADH.

Orientation angle at any measured point in the lateral direction is preferably within ±2° from the average orientation angle of all measurement points, is more preferably within ±1°, but is most preferably ±0.5°.

In the present invention, distribution of in-plane retardation (Ro) is controlled preferably to be at most 5%, more preferably at most 2%, but most preferably at most 1.5%. Further, the distribution (Rt) in the film thickness direction is controlled preferably to be at most 10%, more preferably at most 2%, but most preferably at most 1.5%.

Numerical values in the above retardation distribution are determined as follows. Retardation of the resulting film is determined at 1 cm intervals in the lateral direction, and are represented by the variation coefficient (CV) of the resulting retardation.

Retardation is obtained based on the following formulae, employing 590 nm wavelength at 23° C. and 55% relative humidity.

Ro=(nx−ny)×d Formula (I)

Rt={(nx+ny)/2−nz}×d Formula (II)

wherein nx is the in-plane refractive index in the slow axis direction, ny is the in-plane refractive index in fast axis direction, nz is the refractive index in the film thickness direction, and d is the film thickness (in nm).

Above refractive index is the average refractive index of a sample, which is determined employing an Abbe's refractometer, while the retardation is determined employing an automatic birefringence meter KOBURA-21ADH (produced by Oji Instruments Co., Ltd.).

Further, retardation distribution is determined as follows. The 3-dimensional birefringence of a sample is determined at 1 cm intervals and wavelength 590 nm at 23° C. and 55% relative humidity, employing the above automatic birefringence meter KOBURA-21ADH (produced by Oji Instruments Co., Ltd.). The standard deviation of each of the resulting retardations in the in-plane and thickness directions is obtained based on the (n-1) method. With regard to the retardation distribution, the variation coefficient (CV), described below, is obtained. During actual determination, 130 is set as “n”.

Variation coefficient (CV)=standard deviation/retardation average value

### (6) Winding Process

After the residual solvent amount reaches at most 2% by weight, the resulting web is wound as a polarizing plate protective film. By regulating the residual solvent amount to at most 0.4% by weight, it is possible to produce a film exhibiting the desired dimensional stability.

Any of the commonly employed winding methods may be employed and includes a constant torque method, a constant tension method, a taper tension method, and a constant internal stress programmed tension control method. An appropriate method may be chosen from the above methods and employed.

The polarizing plate protective film of the present invention is preferably a long-length film and specifically includes those of a length of 100-5,000 m, which are commonly provided in the form of a roll. Further, the width of the film is preferably 1.3-4 m, but is more preferably 1.2-2 m.

The moisture vapor transmittance of the polarizing plate protective film of the present invention is specified by the value at 25° C. and 90% relative humidity, determined by the method described in JIS Z 0208. It is preferably 20-250 g/m²·24 hours, but is more preferably 20-200 g/m²·24 hours. When the moisture vapor transmittance exceeds 250 g/m²·24 hours, durability of the polarizing plate is markedly degraded, while when it is less than 20 g/m²·24 hours, the drying time becomes excessive due to difficulty of drying out solvents such as water employed in the adhesives during production of the polarizing plate. The moisture vapor transmittance is most preferably 25-200 g/m²·24 hours.

Mechanical strength of the polarizing plate protective film of the present invention, when represented by tensile elastic modulus at room temperature as an index, is preferably at least 452×10⁹ Pa. The tensile elastic modulus at room temperature is determined based on JIS K 6911.

Transmittance of the polarizing plate protective film of the present invention is preferably at least 90%, is more preferably at least 92%, but is still more preferably at least 93%. Further, haze is preferably at most 0.5%, is more preferably at most 0.1%, but is still more preferably zero.

### (Polarizing Plate)

It is possible to prepare the polarizing plate employed in the present invention, employing common methods. It is preferable that the rear surface of the polarizing plate protective film is adhered to at least one surface of a polarizing film which has been prepared via alkali saponification, immersion in a iodine solution and stretching, employing an aqueous solution of completely saponified type polyvinyl alcohol. Either the aforesaid film or another appropriate polarizing plate protective film may be employed. Preferably employed are commercial cellulose ester films (for example, KONICA MINOLTA TAC KC8UX, KC4UX, KV5UX, KC8UY, KC4UY, KC12UR, KC8UCR-3, KC8UCR-4, KC8UCR-5, KC8UY-HA, KC8UX-RHA, KC4UEW, KC4FR-1, KC4FR-2 and KC4UYW-H-C, all produced by Konica Minolta Opto, Inc. When the polarizing plate protective film is a retardation film, it is possible to obtain a polarizing plate which exhibits excellent visibility and stable viewing angle enhancing effects by employing an antireflection film or an anti-glare/antireflection film as a polarizing plate protective film employed on the other side. Further, when the polarizing plate protective film is an optically isotropic film, it is preferably employed on the front of the display device. In such a case, it is preferable that the surface of the surface protective film is provided with an anti-glare layer or a clear hard-coat layer, and in addition, an antireflection layer, an antistatic layer, and a stain minimizing layer. Further, it is preferable that the polarizing plate protective film employed on the rear surface exhibits in-plane retardation Ro of 15-300 nm at 590 nm and Rt of 70-300 nm. It is possible to prepare these employing the methods described, for example, in JP-A No. 2002-71957 and Japanese Patent Application No. 2002-155395. Alternatively, it is also preferable to prepare a polarizing plate protective film, which also functions as an optical compensation film, incorporating an optical anisotropic layer prepared by orienting liquid crystal compounds such as discotic liquid crystals. For example, it is possible to form an optically anisotropic layer employing the method described in JP-A No. 2003-98348. By doing so, it is possible to prepare a polarizing plate which exhibits excellent flatness and stable viewing angle increasing effects.

A polarizing film, which is a main component of the polarizing plate, is an element which transmits polarized light in only one direction. A currently known representative polarizing film is a polyvinyl alcohol based polarizing film which includes one prepared by dying a polyvinyl alcohol based film with iodine and another prepared by dying the same with dichroic dyes. Polarizing films are employed which are prepared in such a manner that an aqueous polyvinyl alcohol solution is cast, followed by uniaxially stretching and dying, or followed by uniaxial stretching after dying and preferably durability enhancing treatment employing boron compounds. The polymerization degree of polyvinyl alcohol is preferably 100-5000, but more preferably 1400-4000. The thickness of the polarizing film is not specifically limited, however, usually 5-80 μm.

A polarizing plate is prepared by allowing one side of the polarizing plate protective film according to the present invention to adhere to the surface of the aforesaid polarizing film. It is preferable to carry out the above adhesion employing aqueous adhesives incorporating completely saponified polyvinyl alcohol as the main component. Examples include polyvinyl alcohol based adhesives incorporating polyvinyl alcohol and polyvinyl butyral, and vinyl based latexes incorporating butyl acrylate.

Adhesion of a polarizing plate to the release liner is carried out via an adhesive layer. It is preferable to employ adhesives, employed in the aforesaid adhesive layer, which exhibit a modulus elasticity in the range of 1.0×10⁴—1.0×10⁹ Pa during storage in at least one portion of the adhesive layer. Appropriately employed are hardening type adhesives which form polymers or crosslinking structures via various chemical reactions after coating the above adhesives, followed by adhesion. Examples include urethane based adhesives, epoxy based adhesives, aqueous polymer-isocyanate based adhesives, hardening type adhesives such as thermally hardening type acryl adhesives, moisture hardening urethane adhesives, anaerobic adhesives such as polyether methacrylate type, polyester based methacrylate, or oxidizing type polyether methacrylates, cyanoacrylate based instantaneous adhesives, acrylate, and peroxide based 2-liquid instantaneous adhesives. The above adhesives include a single-liquid type and a type in which at least two liquids are blended and then used. Further, the above adhesives include a solvent based one incorporating organic solvents as media, and a water based one such as an emulsion type incorporating water as a main component, a colloid dispersion type, or an aqueous solution type, and a non-solvent type. The appropriate concentration of the above adhesive liquid may be determined depending on the layer thickness after adhesion, the coating method, and the coating conditions, and is commonly 1-50 % by weight. The thickness of the adhesive layer can be optionally determined depending on the purpose or on the adhesive forth, however, usually it is 1-500 μm, more preferably 5-200 μm, and specifically 10-100 μm.

### (Liquid Crystal Display)

By arranging the polarizing plate adhered to the polarizing plate protective film of the present invention in a liquid crystal display, it is possible to prepare various liquid crystal displays, all of which exhibit excellent visibility. The release liner of the polarizing plate according to the present invention is peeled away and the liquid cell is adhered to the liquid crystal cell via the above adhesive layer.

The polarizing plate according to the present invention is preferably employed in a reflection type, transmission type, or semi-transmission type LCD, or various type driving system LCDs such as a TN type, an STN type, an OCB type, an HAN type (being a PVA type and an MVA type), or an IPS type. Specifically, in display devices of a large image area of at least 30 type, specifically 30-54 type, no white portions near the periphery occur, and the resulting effects are maintained for an extended period of time. Specifically, in an MVA type image display device, marked desirable effects are noted. Further, color shading, glare, and wavy unevenness are minimized, resulting in suck the desired effect that eyes do not tire even over long duration viewing.

### EXAMPLES

The present invention will now be described with reference to examples; however, the present invention is not limited thereto.

### Example 1

### (Preparation of Surface Protective Film and Release Liner)

### (Preparation of PET Film)

Added to 100 parts by weight of dimethyl terephthalate, 65 parts by weight of ethylene glycol, and 2 parts by weight of diethylene glycol was 0.05 part by weight of magnesium acetate hydrate as a transesterification catalyst, and the resulting mixture underwent transesterification via a conventional method. Added to the resulting product were 0.05 part by weight of antimony trioxide, and 0.03 part by weight of trimethyl phosphate. Subsequently, the temperature was gradually raised and the pressure was gradually reduced. Polymerization was performed at 280° C. and 67 Pa, whereby polyethylene terephthalate at an intrinsic viscosity of 0.70 was prepared.

Further, after the resulting polyethylene terephthalate was subjected to vacuum drying at 150° C. over 8 hours, it was melt-extruded at 285° C., employing an extruder, brought into contact onto a 30° C. cooling drum under electrostatic application, cooled, and solidified, whereby an unstretched sheet was prepared. The resulting unstretched sheet was then stretched at 85° C. by a factor of 1.2 in the longitudinal direction, employing a roller system longitudinal stretching apparatus. Temperature difference between the front and the rear surfaces was within 5° C.

The resulting uniaxially stretched film was further stretched at 95° C. by a factor of 4.5 in the lateral direction, employing a tenter system lateral stretching apparatus, followed by heat treating at 70° C. for 2 seconds. Further, in a 150° C. initial heat-fixing zone, heat-fixing was carried out for 10 seconds, then in a 180° C. second heat fixing zone, heat fixing was carried out for 15 seconds, and relaxation in the lateral (width) direction was carried out at 160° C., followed by winding, whereby a biaxially stretched polyethylene terephthalate (PET) film at a width of 1.4 m and a thickness of 10 μm was prepared.

Further, during casting of the PET film, 11 types of PET films were prepared in varying thicknesses of 20, 30, 40, 50, 60, 90, 100, 200, and 220 μm.

Eleven types of PET films, prepared as above, were employed as the surface protective film and the release liner as shown in Table 1.

(Preparation of Cellulose Ester Film)
(Minute Particle Dispersion)

| | |
|---|---|
| AEROSIL 972V (average diameter of | 12 parts by weight |
| primary particles of 16 nm | |
| and apparent specific gravity | |
| of 90 g/liter, produced by | |
| Nippon Aerosol Co., Ltd.) | |
| Ethanol | 88 parts by weight |

While stirring, the above components were mixed for 30 minutes employing a dissolver. Thereafter, the resulting mixture was dispersed employing MANTON GAULIN. While stirring, 88 parts by weight of methylene chloride were added to a silicon dioxide dispersion, and the resulting mixture was mixed while stirring for 30 minutes employing a dissolver, whereby a diluted minute particle dispersion was prepared.

(Preparation of In-Line Addition Liquid)

| | |
|---|---|
| TINUVIN 109 (produced by Ciba | 11 parts by weight |
| Specialty Chemicals, Corp.) | |
| TINUVIN 171 (produced by Ciba | 5 parts by weight |
| Specialty Chemicals, Corp.) | |
| Methylene chloride | 100 parts by weight |

The above components were placed in a sealed vessel, and heated. while stirring, complete dissolution was carried out, followed by filtration.

While stirring, 36 parts by weight of the diluted particles dispersed liquid were added to the above solution. After stirring for an additional 30 minutes, 6 parts by weight of cellulose acetate propionate (at a degree of substitution of an acetyl group of 1.9 and a degree of substitution of a propionyl group of 0.8) were added while stirring. After stirring for an additional 60 minutes, the resulting mixture was filtered via a polypropylene wind cartridge filter TCW-PPS of Advantech Toyo Co., Ltd., whereby an in-line addition liquid was prepared.

(Dope)

| | |
|---|---|
| Cellulose acetate propionate (at | 100 parts by weight |
| a degree of substitution of | |
| an acetyl group of 2.0, a | |
| degree of substitution of a | |
| propionyl group of 0.7, an | |
| Mn of 80,000, and a Mw/Mn of 2.5) | |
| Trimethylolpropane tribenzoate | 5 parts by weight |
| Ethylphthalyl ethyl glycolate | 5 parts by weight |
| methylene chloride | 430 parts by weight |
| Methanol | 40 parts by weight |

The above components were placed in a sealed vessel, heated while stirring, completely dissolved, and filtered via AZUMI FILTER PAPER No. 24, produced by Azumi Filter Paper Co., Ltd., whereby a dope was prepared.

In a casting line, the dope was filtered by FINE MET NF, produced by Nippon Seisen Co., Ltd. In the in-line addition liquid line, the in-line addition liquid was filtered by FINEMET NF, produced by Nippon Seisen Co., Ltd. The filtered in-line addition liquid was added to the filtered dope in an amount of 2 parts by weight with respect to 100 parts by weight of the filtered dope. The resulting mixture was sufficiently blended employing an in-lime mixer (Toray stationary type in-pipe mixer HI-MIXER, SWJ), and then at 35° C. uniformly cast at a width of 2 m onto a stainless steel band support, employing a belt casting apparatus.

Thereafter, drying was carried out to the range in which peeling was possible. Subsequently, the web was peeled from the stainless steel band support. At that time, the residual solvent amount in the web was 80%. Time required from the dope casting to the peeling was 3 minutes. After peeling the web from the stainless steel belt support, drying was carried out at 120° C. while stretching by a factor of 1.1 in the lateral direction, employing a tenter. Thereafter, width holding was released and dried at 120° C. under conveyance employing a number of rollers. Drying was completed in a 135° C. drying zone. Subsequently, both edges of the resulting film were subjected to knurling at a width of 10 mm and a height of 5 μm, whereby a 40 μm thick cellulose ester film was produced. The film width was specified to 1.4 m and the winding length was specified to 3,000 m. The initial winding tension was specified to 150 N/1.4 m, while the final winding tension was specified to 1,000 N/1.4 m.

The retardation of the resulting cellulose ester film was determined by the following method, resulting in an Ro of 40 nm and an Rt of 135 nm.

### <Measurement of Ro and Rt>

The average refractive index of a cellulose ester film was determined employing an Abbe's refractometer (4T). Film thickness was determined employing a typical commercial micrometer.

By employing birefringence meter KOBRA-21ADH (produced by Oji Scientific Instruments), the retardation of the film, which was allowed to stand at 23° C. and 55% relative humidity for 24 hours, was determined at wavelength 590 nm under the same ambience as above. The in-plane retardation (Ro) and the retardation in the thickness direction (Rt) were defined in the following formulas.

Ro=(nx−ny)×d Formula (I)

Rt={(nx+ny)/2−nz}×d Formula (II)

wherein nx is the in-plane refractive index in the slow axis direction, ny is the in-plane refractive index in the fast axis direction, nz is the refractive index in the film thickness direction and d is the thickness (in nm) of the film.

Further, in preparation of the above cellulose ester film, 5 types of film, which differed in film thickness, were prepared in the same manner, except that the film thickness was specified to 20, 30, 60, and 80 μm.

### (Preparation of Polarizing Plate)

### <Preparation of Polarizing Film>

A 120 μm thick polyvinyl alcohol film was immersed in a 100 parts by weight of an aqueous solution incorporating 1 part by weight of iodine and 4 parts by weight of boric acid, and stretched at 50° C. by a factor of 4, whereby a polarizing film at a width of 1.4 m was prepared. The film thickness was 25 μm.

### <Preparation of Polarizing Plate>

Each of the 5 types of the cellulose ester film, prepared as above, was subjected to alkali treatment employing a 5 mol/L aqueous sodium hydroxide solution at 40° C. for 60 seconds, washed with water for 3 minutes, and underwent saponification, whereby an alkali treated film was prepared.

Subsequently, each of the polarizing plates employing the cellulose ester film listed in Table 1 was prepared in such a manner that one of the 5 types of the cellulose ester film prepared as above, the polarizing film, prepared as above, and KONICA MINOLTA TAC KC4UY (at a thickness of 40 μm, produced by Konica Minolta Opto, Inc.), which is a commercial polarizing plate protective film, were adhered in the above order, employing a 5% aqueous completely saponified type polyvinyl alcohol solution.

### (Adhesion of Surface Protective Film and Release Liner)

By employing the PET film and the polarizing plate, prepared as above, the surface protective film and the release liner were adhered to the polarizing plate to result in the constitution shown in Table 1, whereby Polarizing Plates 1-22 each having a surface protective film and a release liner were prepared. Polarizing plate 23 having a surface protective film and a release liner was prepared in the same manner as above except that the surface protective film was changed to a polyethylene film TORETEC® produced by TORAY ADVANCED FILM Co., Ltd.

At that time, the release liner was prepared in such a manner that Adhesive Composition A, described below, was applied onto above PET film which was subjected to a silicone peeling treatment, then dried at 150° C. for 2 minutes and subjected to peroxide decomposition treatment. The resulting release liner was adhered to a polarizing plate.

### (Preparation of Adhesive Composition A)

Placed in a 4-necked flask fitted with a nitrogen introducing pipe and a cooling pipe were 95 parts by weight of butyl acrylate, 3.0 parts by weight of acrylic acid, 0.10 part by weight of 2-hydroxyethyl acrylate, 0.050 part by weight of 2,2-azobisisobutyronitrile, and 200 parts by weight of ethyl acetate. After completely replacing the flask interior with nitrogen, under a flow of nitrogen, while stirring, the resulting mixture underwent polymerization at 55° C. for 20 hours, whereby a solution of Acryl Polymer A at a high average molecular weight of 1,570,000 was prepared.

The adhesive composition described above was prepared by uniformly blending, with 100 parts (in solids) by weight of above Acrylic Polymer A solution, 0.15 part by weight of dibenzoyl peroxide, 0.080 part by weight of 3-glycidoxypropyl trimethoxysilane as a silane coupling agent, and 0.60 part by weight of an isocyanate based crosslinking agent (CORONATE L, produced by Nippon Polyurethane Industry Co., Ltd).

### <<Evaluation>>

Each of the resulting polarizing plates was evaluated for defects of polarizing plate adhesion to the liquid crystal cell, peeling of the release liner, polarizing plate folding and wrinkling, and polarizing plate conveyance, as well as the yield of the polarizing plate adhesion process. Table 1 shows the results.

Each of resulting surface protective film/release liner adhered Polarizing Plates 1-16 was individually adhered to both sides of 100 liquid crystal cells in the NVA typo liquid crystal panel production process, employing the automatic laminating apparatus 1000 shown in FIG. 6.

In FIG. 6, symbol 1 represents a liquid crystal cell substrate, 2 and 3 each represent a polarizing plate, 10 represents a conveyance line, 100 represents a cleaning conveyance line, 300 represents a first polarizing plate laminating line, (an adhesion line on the CF (color filter) side of the polarizing plate), 301 and 401 each represent a cleaning roller, 302 and 402 each represent an alignment station, 303 and 403 each represent a CCD camera, 310 and 410 each present a polarizing plate adhesion station, 400 represents a second polarizing plate adhesion line, (an adhesion line on the TFT side of the polarizing plate), 500 represents a first polarizing plate feeding line, 501 and 601 each represent a polarizing plate cartridge port, 502 and 602 each represent a polarizing plate conveyance station, 503 and 603 each represent a polarizing plate picking-up station, 504 and 604 each represent a polarizing plate cleaner, 505 and 605 each represent a polarizing plate alignment station, and 700 and 800 each represent each a reversal station.

Defects formed in the above automatic adhesion were classified and the following defects causes were found. Failure in peeling of the release liner:

In the polarizing plate adhesion process (310 and 410 in FIG. 6), recorded was the frequency of cases in which it was not possible to peel the release liner.

### Failure in Polarizing Plate Conveyance:

In the polarizing plate conveyance processes (501-505 and 601-605 in FIG. 6), recorded was the frequency of cases, in which failure in conveyance occurred in such a manner that the polarizing plate was trapped by the conveyance belt or the polarizing plate cleaner.

Further, a liquid crystal cell after the polarizing plate lamination, was visually observed employing a 10 power magnifying glass, non-defective products and defective products were separated. Subsequently, causes of the non-defective products were classified, resulting in the following defective causes.

### Defect Due to Fold-Wrinkling of Polarizing Plates:

This refers to a defect in which about 1-about 5 mm fold-wrinkling was observed on the adhered polarizing plate. The fold-wrinkling mainly occurred when the polarizing plate was picked up from the polarizing plate cartridge port.

### Failure in Polarizing Plate Adhesion:

This failure refers to inclusion of air bubbles of a diameter of 0.1 mm or more in the adhered polarizing plate or a portion of 0.1 mm or more which is not adhered at the periphery.

### Yield of Polarizing Plate Adhesion Process:

The yield of non-defective products was calculated based on the following formula.

$$\begin{matrix}Yield ( in \% ) = number of non \text{-} defective sheets / \\ ( number of non \text{-} defective sheets + \\ number of defective sheets ) \times 100\end{matrix}$$

### (Corner Unevenness)

The polarizing plate and optical compensation film of 32-sized liquid crystal television KDL-32V2000 produced by SONY Corp. were removed, and each of the inventive polarizing plates and comparative polarizing plates prepared as above was adhered on the liquid crystal television so that the absorption axis of the polarizing plate lies in the same direction as the absorption axis of the originally installed polarizing plate in this manner, liquid crystal displays were fabricated. The obtained liquid crystal displays were stored under a condition of 60° C., 90% RH for 1500 hours, followed by turning on the liquid crystal displays. 6 hours after the liquid crystal displays were turned on, existence of leakage of light at the corner (corner unevenness) of each display was visually checked. The results were evaluated in the following criteria.

A: No leakage of light the corner was observed.

B: The leakage of light at the corner was ignorable.

C: Leakage of light at the corner was clearly observed.

D: Leakage of light at the corner was notably observed.

TABLE 1

| Surface | | | | | | | | | | | |
|---|---|---|---|---|---|---|---|---|---|---|---|
| Protective | | | | | | | | | | | |
| film/ | | | | | | | | | | | |
| Release | | | | Difference | Failure | Failure | | Failure | | | |
| liner | | | | in | in | in | | in | | | |
| Laminated | | *2 | *3 | Thickness | Polarizing | Release | Fold- | Polarizing | | | |
| Polarizing | | (A) | (B) | (A) − (B) | Plate | Liner | Wrinkling | Plate | *4 | Corner | |
| Plate No. | *1 | (μm) | (μm) | (μm) | Conveyance | Peeling | Defect | Adhesion | (%) | Unevenness | Remarks |
| 1 | 40 | 40 | 60 | −20 | 2 | 27 | 2 | 24 | 45 | B | Comp. |
| 2 | 40 | 50 | 30 | 20 | 3 | 3 | 3 | 3 | 88 | A | Inv. |
| 3 | 40 | 60 | 40 | 20 | 3 | 2 | 3 | 2 | 90 | A | Inv. |
| 4 | 40 | 100 | 90 | 10 | 3 | 31 | 2 | 2 | 62 | A | Comp. |
| 5 | 40 | 100 | 80 | 20 | 2 | 2 | 2 | 2 | 92 | A | Inv. |
| 6 | 40 | 100 | 50 | 50 | 0 | 0 | 0 | 0 | 100 | A | Inv. |
| 7 | 40 | 100 | 20 | 80 | 2 | 2 | 3 | 2 | 91 | A | Inv. |
| 8 | 40 | 200 | 40 | 160 | 28 | 2 | 3 | 2 | 65 | A | Comp. |
| 9 | 40 | 200 | 100 | 100 | 2 | 3 | 2 | 2 | 91 | A | Inv. |
| 10 | 40 | 200 | 200 | 0 | 1 | 26 | 2 | 1 | 70 | A | Comp. |
| 11 | 40 | 220 | 100 | 120 | 1 | 2 | 42 | 1 | 54 | A | Comp. |
| 12 | 40 | 100 | 10 | 90 | 40 | 0 | 1 | 1 | 58 | A | Comp. |
| 13 | 30 | 100 | 50 | 50 | 1 | 1 | 2 | 1 | 95 | A | Inv. |
| 14 | 60 | 100 | 50 | 50 | 0 | 0 | 0 | 0 | 100 | C | Inv. |
| 15 | 20 | 100 | 10 | 90 | 22 | 21 | 12 | 17 | 28 | B | Comp. |
| 16 | 80 | 100 | 10 | 90 | 23 | 2 | 3 | 2 | 70 | D | Comp. |
| 17 | 20 | 100 | 50 | 50 | 20 | 3 | 10 | 15 | 52 | B | Comp. |
| 18 | 80 | 100 | 50 | 50 | 1 | 1 | 0 | 1 | 97 | D | Comp. |
| 19 | 40 | 200 | 80 | 120 | 10 | 1 | 8 | 1 | 80 | A | Inv. |
| 20 | 40 | 200 | 180 | 20 | 9 | 8 | 0 | 1 | 82 | A | Inv. |
| 21 | 40 | 50 | 20 | 30 | 7 | 6 | 1 | 2 | 84 | A | Inv. |
| 22 | 40 | 140 | 20 | 120 | 8 | 5 | 1 | 1 | 85 | A | Inv. |
| 23 | 40 | 60 | 40 | 20 | 5 | 4 | 4 | 3 | 84 | A | Inv. |

*1: Thickness of Cellulose Ester Film,
*2: Thickness of Overcoat Film
*3: Thickness of Separate film,
*4: Yield of Polarizing Plate Adhesion Process
Inv.: Inventive,
Comp.: Comparative

As can be seen from the results in Table 1, polarizing plates, to which the surface protective film and the release liner of the present invention were laminated, exhibited minimal failure of lamination of the polarizing plate onto the liquid crystal cell, minimal failure of release liner peeling, minimal formation of fold-wrinkling of the polarizing plate and minimal conveyance trouble of the polarizing plate, and thus improved production yield in the polarizing plate lamination process was observed.

The cellulose ester films of each of Polarizing plate Nos. 2, 3, 6, 7, 9 and 13 each provided with a surface protective film and a release liner were changed to ZEONOR® films produced by ZEON Corp. (glass transition temperature: 136° C.). Thus obtained polarizing plates each provided with a surface protective film and a release liner were evaluated in the same manner as above, and the same effects as described above were observed.

What is claimed is:

1. A polarizing plate comprising a polarizing film and two polarizing plate protective films each having a thickness of 30-60 μm provided on both surfaces of the polarizing film, the polarizing plate further comprising a surface protective film adhered on one surface of the polarizing plate and a release liner adhered on the other surface of the polarizing plate, wherein
(A) and (B) simultaneously meet the following conditions, provided that (A) represents a thickness of the surface protective film and (B) represents a thickness of the release liner.
50≦(A)≦200 (μm) Condition (i)
20≦(B) (μm) Condition (ii)
20≦(A)−(B)≦120 (μm) Condition (iii)

2. The polarizing plate of claim 1, wherein the surface protective film comprises polyethylene, polyester or polypropylene.

3. The polarizing plate of claim 1i wherein the surface protective film comprises polyester.

4. The polarizing plate of claim 1, wherein the release liner comprises polyethylene, polyester or polypropylene.

5. The polarizing plate of claim 1, wherein the release liner comprises polyester.

6. The polarizing plate of claim 1, wherein the polarizing plate protective film comprises cellulose ester, polyacrylate or cycloolefine polymer.

7. The polarizing plate of claim 1, wherein a thickness of the release liner (B) is 20-50 μm.

8. The polarizing plate of claim 1, wherein a thickness of the release liner (B) is larger than 50 μm.

9. A liquid crystal display comprising the polarizing plate of claim 1.
